(19) United States
(12) Patent Application Publication
(10) Pub. No.: US 2016/0350099 A1
(43) Pub. Date: Dec. 1, 2016

(54) APPLICATION DEPLOYMENT TO VIRTUAL MACHINES

(71) Applicant: HEWLETT PACKARD ENTERPRISE DEVELOPMENT LP, Houston, TX (US)

(72) Inventors: Adarsh Suparna, Bangalore (IN); Pramod Kumar Ramachandra, Bangalore (IN); Gajanan Rameshwar More, Bangalore (IN)

(21) Appl. No.: 15/162,865

(22) Filed: May 24, 2016

(30) Foreign Application Priority Data
May 29, 2015 (IN) 2714/CHE/2015

(51) Int. Cl. G06F 9/445; G06F 11/36; G06F 9/455

(52) U.S. Cl. CPC G06F 8/65; G06F 9/45558; G06F 11/368; G06F 2009/4557

(57) ABSTRACT

Examples disclosed herein relate to application deployment instructions to receive a new version of an application, select, from a pool of available virtual machines, a target virtual machine comprising a prior version of the application, and deploy the new version of the application to the target virtual machine.

### BACKGROUND

Virtual machine instances allow for multiple logical computing systems to share physical hardware and resources. In some situations, applications and services may utilize these virtual machine instances across the development, testing, staging, and production phases of deployment.

### BRIEF DESCRIPTION OF THE DRAWINGS

In the accompanying drawings, like numerals refer to like components or blocks. The following detailed description references the drawings, wherein:

FIG. 1 is a block diagram of an example application deployment device;

FIG. 2 is a flowchart of an example of a method for application deployment; and

FIG. 3 is a block diagram of an example system for application deployment.

### DETAILED DESCRIPTION

As described above, a computer may operate a hypervisor that serves as an interface between the computer's physical hardware and a plurality of virtual machines. The virtual machines (VMs) may each comprise an operating system and a suite of applications and/or services, including an application deployed by a provider and/or developer. For example, a human resources application with a web-based interface may be deployed to virtual machines by a provider during development, testing, staging, and production phases to avert the need for separate physical machines for each phase.

A virtual machine monitor (VMM), or hypervisor, manages the resources of any underlying physical hardware and provides for the abstraction of one or multiple VMs. Each operating system, for example, running in a VM appears to have the host's processor, memory, and other resources, or at least a portion thereof. However, the hypervisor is actually controlling the host processor and resources and allocating what is needed to each operating system in turn and making sure that the guest operating systems cannot disrupt each other. The creation of new instances of virtual machines often consumes a great deal of resources and adds complexity to the management of a pool of virtual machines. Re-using virtual machines that have already been assigned to a particular task may help alleviate this management burden.

In the description that follows, reference is made to the term, “machine-readable storage medium.” As used herein, the term “machine-readable storage medium” refers to any electronic, magnetic, optical, or other physical storage device that stores executable instructions or other data (e.g., a hard disk drive, random access memory, flash memory, etc.).

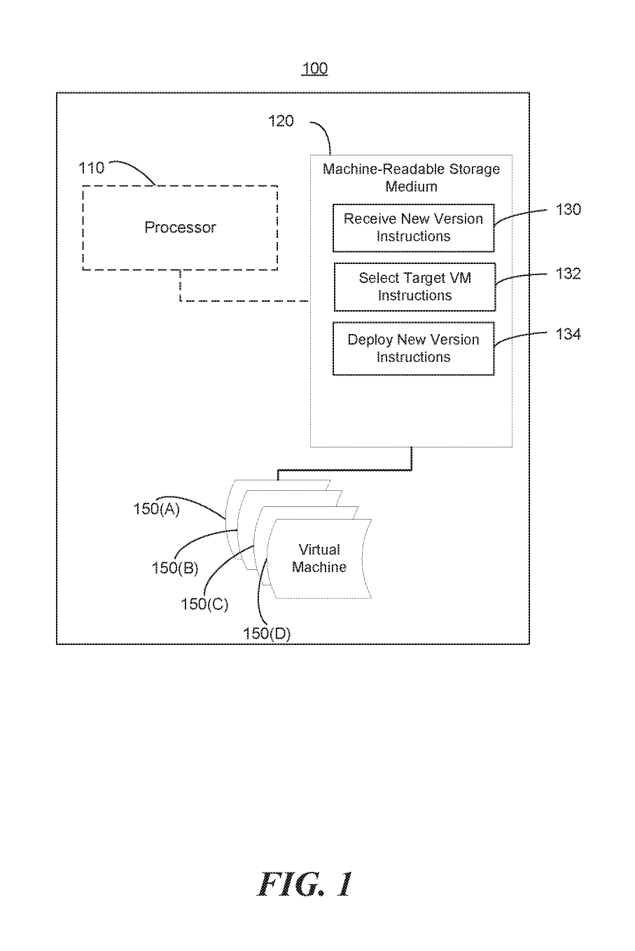

Referring now to the drawings, FIG. 1 is a block diagram of an example application deployment device 100 consistent with disclosed implementations. Application deployment device 100 may comprise a processor 110 and a non-transitory machine-readable storage medium 120. Application deployment device 100 may comprise a computing device such as a server computer, a desktop computer, a laptop computer, a handheld computing device, a smart phone, a tablet computing device, a mobile phone, or the like.

Processor 110 may comprise a central processing unit (CPU), a semiconductor-based microprocessor, or any other hardware device suitable for retrieval and execution of instructions stored in machine-readable storage medium 120. In particular, processor 110 may fetch, decode, and execute a plurality of receive new version instructions 130, select target virtual machine instructions 132, and deploy new version instructions 134 to implement the functionality described in detail below. Device 100 may further comprise a plurality of virtual machines 150(A)-(D).

Executable instructions may be stored in any portion and/or component of machine-readable storage medium 120. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

With virtualization, a fraction of a CPU such as processor 110 and a slice of networking and storage bandwidth may be assigned to each virtual machine 150(A)-(D) that is running on a physical machine. Each virtual machine 150(A)-(D) may be assigned specific device 100 resources, such as networking cards, data storage, digital memory, and computer processors. The amount of resources that are assigned, and the way in which the resources are assigned, may vary depending upon the needs of the virtual machine, the availability of the resources, and the desires of a user. Although FIG. 1 depicts virtual machines 150(A)-(D) operating on device 100 for ease of reference, additional virtual machines may operate on other devices in communication with device 100, such as other server computers in a data center and/or other cluster of computing devices.

Receive new version instructions 130 may receive a new version of an application. For example, receive new version instructions 130 may scan a code repository, an integration server, and/or an application store for new versions of the application. For another example, a developer and/or administrator may upload a new version of the application to device 100 for deployment.

In some implementations, the receive new version instructions 130 may cause processor 110 to determine whether the new version of the application passes a plurality of build tests. If not, the new version of the application may be rejected for deployment. For example, a checksum may be calculated on the compiled executable of the application and compared to an expected checksum associated with the new version of the application. For another example, the receive new version instructions 130 may use an inventory list of components of the new version of the application to ensure that all of the components are present in an application package.

Select target virtual machine instructions 132 may select, from a pool of available virtual machines, a target virtual machine comprising a prior version of the application. For example, a plurality of deployment rules may be used to identify which of virtual machines 150(A)-(D) may be selected for deployment of the new version of the application. Each deployment rule may comprise at least one condition, such as a virtual machine state condition, a virtual machine configuration condition, an application version condition, a deployment age condition, and a deployment status condition.

Virtual machine states may, for example, comprise a length of time the virtual machine has been operating and/or an active, available, unused or inactive state. In some implementations, if a previously deployed application version has encountered errors in deployment and/or execution, the associated virtual machine may be placed into an inactive state until the error has been evaluated and the virtual machine may be ineligible and/or at a lower priority for selection.

Virtual machine configurations may, for example, comprise available resources, processor power, memory, virtualized hardware, and/or installed software/services. In some implementations, a new version of an application may comprise a requirement for a minimum amount of memory and/or a specific version of a supporting service, such as a database driver. Virtual machines without that configuration may thus be ineligible for selection.

Application version conditions may be used to prioritize selection of virtual machines based on the version of the application currently deployed to each virtual machine. For example, a deployment of the new version of the application may target a specific previous version for an upgrade and/or the deployment may replace the earliest build version deployed on virtual machines 150(A)-(D).

Deployment age conditions may be used in selection of a target virtual machine based on the length of time a previous version has been deployed to a given virtual machine. For example, virtual machine 150(A) and virtual machine 150(B) may each comprise the same previous version of the application, but that version may have been deployed to virtual machine 150(A) for ten days and to virtual machine 150(B) for six days. In some implementations, the older deployment may be selected for re-deployment of the new application.

A deployment status condition may comprise a current state of the previously deployed version of the application on each virtual machine 150(A)-(D). For example, states may comprise active, inactive, high load, backup, currently testing, and/or error states. In some implementations, applications in inactive states may be preferred for redeployment rather than applications undergoing active testing and/or high user load. Applications in an error state may need to be maintained with the previous version of the application until the error has been evaluated.

Deploy new version instructions 134 may deploy the new version of the application to the target virtual machine. In some implementations, the instructions to deploy the new version of the application to the target virtual machine may cause processor 110 to remove the prior version of the application from the target virtual machine and/or to replace a component of the prior version of the application with an updated component from the new version of the application.

For example, a new version (e.g., version 1.2.2) of an application may comprise a new graphics library relative to a previously deployed version (e.g., version 1.2.1) of an application. Deploy new version instructions 134 may halt execution of the previous version of the application on virtual machine 150(A). The overall application may be replaced with the new version on virtual machine 150(A) and/or only the new component, such as the new graphics library in this example, may be copied to virtual machine 150(A). The updated application may then be restarted and/or resumed on virtual machine 150(A).

In some implementations, deploy new version instructions 134 may cause processor 110 to determine whether the deployed new version of the application passes a plurality of performance tests. If an error is determined to occur during the performance tests, deploy new version instructions 134 may save a current state of the target virtual machine (e.g., configuration information, resource allocations and usage, installed applications and services, network connection information, snapshots of memory pages, etc.), and remove the target virtual machine from the pool of available virtual machines.

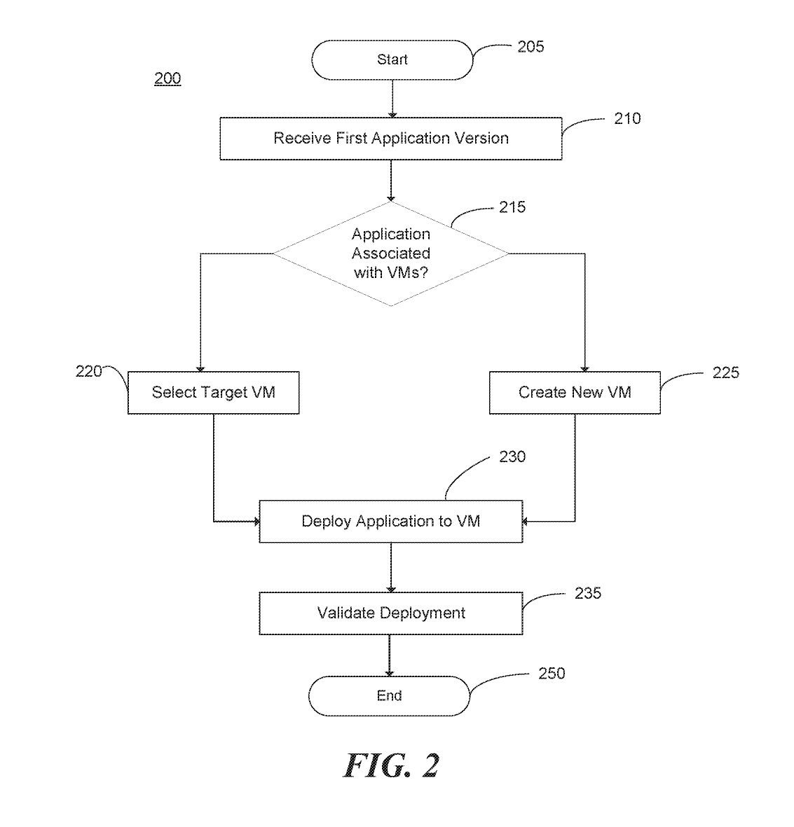

FIG. 2 is a flowchart of a method 200 for application deployment consistent with disclosed implementations. Although execution of method 200 is described below with reference to the components of application deployment device 100, other suitable components for execution of method 200 may be used.

Method 200 may begin in stage 205 and proceed to stage 210 where device 100 may receive a first version of an application for deployment. In some implementations, receive new version instructions 130 may receive a new version of an application. For example, receive new version instructions 130 may scan a code repository, an integration server, and/or an application store for new versions of the application. For another example, a developer and/or administrator may upload a new version of the application to device 100 for deployment.

In some implementations, the receive new version instructions 130 may cause processor 110 to determine whether the new version of the application passes a plurality of build tests. If not, the new version of the application may be rejected for deployment. For example, a checksum may be calculated on the compiled executable of the application and compared to an expected checksum associated with the new version of the application. For another example, the receive new version instructions 130 may use an inventory list of components of the new version of the application to ensure that all of the components are present in an application package.

Method 200 may then advance to stage 215 where device 100 may determine whether the application is associated with a plurality of virtual machines. In some implementations, determining whether the first version of the application is associated with a plurality of virtual machines may comprise determining whether the first version of the application comprises a major version change from the second version of the application. For example, a move from version 1.2.2 to version 2.0.0 may comprise a major version change. For another example, a new version associated with a new operating system platform or different programming language may comprise a major version change. If the new version comprises is determined to comprise a major version change, then any existing virtual machines may be determined not to be associated with the application at stage 215.

If, at stage 215, the application is determined to be associated with a plurality of VMs, method 200 may advance to stage 220 where device 100 may select, according to a deployment rule, a target virtual machine of the plurality of virtual machines, wherein the target virtual machine comprises a second version of the application. Select target virtual machine instructions 132 may select, from a pool of available virtual machines, a target virtual machine comprising a prior version of the application. For example, a plurality of deployment rules may be used to identify which of virtual machines 150(A)-(D) may be selected for deployment of the new version of the application. Each deployment rule may comprise at least one condition, such as a virtual machine state condition, a virtual machine configuration condition, an application version condition, a deployment age condition, and a deployment status condition.

Virtual machine states may, for example, comprise a length of time the virtual machine has been operating and/or an active, available, unused or inactive state. In some implementations, if a previously deployed application version has encountered errors in deployment and/or execution, the associated virtual machine may be placed into an inactive state until the error has been evaluated and the virtual machine may be ineligible and/or at a lower priority for selection.

If, at stage 215, the application is determined not to be associated with a plurality of VMs, method 200 may advance to stage 225 where device 100 may create a new virtual machine. The new virtual machine may be created using a memory image created by a hypervisor on a computing system such as device 100. A VM may be created using a machine image of the desired VM. The machine image may comprise a template that provides the VM with a bootable operating system and defined software applications. A machine image may be cloned onto a volume which is mounted to the VM, i.e. attached to the VM for write and read access. The VM may be created with various volumes attached to it, such as bootable volumes and storage volumes.

After selecting a target VM at stage 220 or creating a new VM at stage 225, method 200 may advance to stage 230 where device 100 may deploy the first version of the application to the target virtual machine. In some implementations, deploying the first version of the application to the target virtual machine may comprises identifying at least one differing component between the first version and the second version of the application and replacing the at least one differing component of the second version of the application with the at least differing component of the first version of the application.

Method 200 may then advance to stage 235 where device 100 may validate the deployment of the first version of the application to the target virtual machine. In some implementations, deploy new version instructions 134 may deploy the new version of the application to the target virtual machine. In some implementations, the instructions to deploy the new version of the application to the target virtual machine may cause processor 110 to remove the prior version of the application from the target virtual machine and/or to replace a component of the prior version of the application with an updated component from the new version of the application.

For example, a new version (e.g., version 1.2.2) of an application may comprise a new graphics library relative to a previously deployed version (e.g., version 1.2.1) of an application. Deploy new version instructions 134 may halt execution of the previous version of the application on virtual machine 150(A). The overall application may be replaced with the new version on virtual machine 150(A) and/or only the new component, such as the new graphics library in this example, may be copied to virtual machine 150(A). The updated application may then be restarted and/or resumed on virtual machine 150(A).

In some implementations, deploy new version instructions 134 may cause processor 110 to determine whether the deployed new version of the application passes a plurality of performance tests. If an error is determined to occur during the performance tests, deploy new version instructions 134 may save a current state of the target virtual machine (e.g., configuration information, resource allocations and usage, installed applications and services, network connection information, snapshots of memory pages, etc.), and remove the target virtual machine from the pool of available virtual machines.

Method 250 may then end at stage 275.

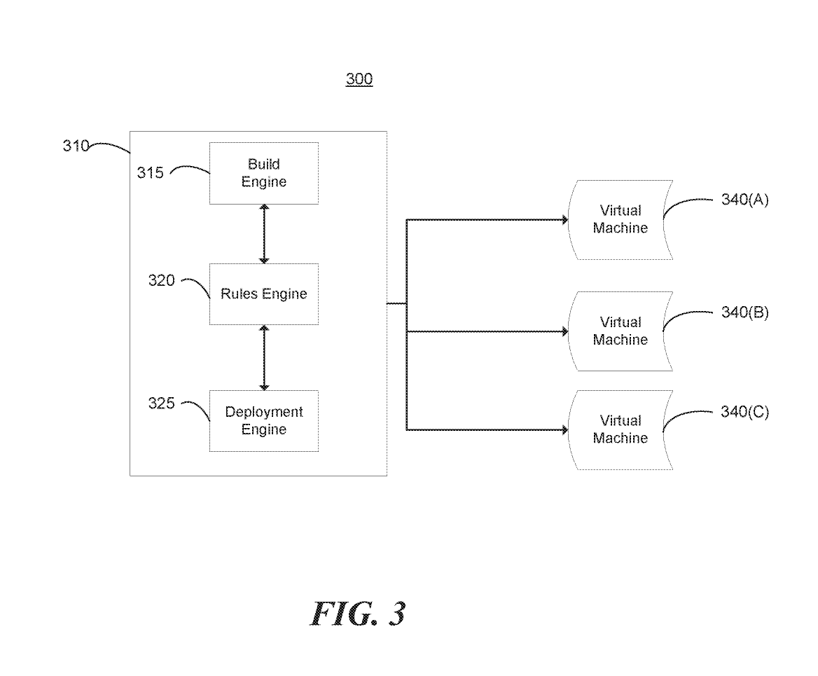

FIG. 3 is a block diagram of a system 300 for application deployment. System 300 may comprise a computing device 310 comprising a build engine 315, a rules engine 320, and a deployment engine 325. System 300 may further comprise a plurality of virtual machines (VMs) 340(A)-(C).

Computing device 310 may comprise, for example, a general and/or special purpose computer, server, mainframe, desktop, laptop, tablet, smart phone, game console, and/or any other system capable of providing computing capability consistent with providing the implementations described herein.

Each of engines 315, 320, and 325 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium and the hardware for the engines may include a processing resource to execute those instructions. In such examples, the machine-readable storage medium may store instructions that, when executed by the processing resource, implement engines 315, 320, and 325. In such examples, system 300 may comprise the machine-readable storage medium storing the instructions and the processing resource to execute the instructions, or the machine-readable storage medium may be separate but accessible to system 300 and the processing resource.

Build engine 315 may receive and/or compile a new version of an application. In some implementations, receive new version instructions 130 may receive a new version of an application. For example, receive new version instructions 130 may scan a code repository, an integration server, and/or application store for new versions of the application. Build engine 315 may, in some implementations, detect an updated component (e.g., a modified class module file) in a repository and compile a new version of the application. For another example, a developer and/or administrator may upload a new version of the application to device 100 for deployment.

In some implementations, the receive new version instructions 130 may cause processor 110 to determine whether the new version of the application passes a plurality of build tests. If not, the new version of the application may be rejected for deployment. For example, a checksum may be calculated on the compiled executable of the application and compared to an expected checksum associated with the new version of the application. For another example, the receive new version instructions 130 may use an inventory list of components of the new version of the application to ensure that all of the components are present in an application package.

Rules engine 320 may index a plurality of virtual machines associated with the application, wherein the index comprises a plurality of configuration information for each of the plurality of virtual machines, and select, according to a deployment rule, one of the plurality of virtual machines for deployment of the new version of the application. In some implementations, select target virtual machine instructions 132 may select, from a pool of available virtual machines, a target virtual machine comprising a prior version of the application. For example, a plurality of deployment rules may be used to identify which of virtual machines 150(A)-(D) may be selected for deployment of the new version of the application. Each deployment rule may comprise at least one condition, such as a virtual machine state condition, a virtual machine configuration condition, an application version condition, a deployment age condition, and a deployment status condition.

Deployment engine 325 may suspend execution of a deployed instance of the application on the selected one of the plurality of virtual machines, wherein the deployed instance of the application comprises a prior version of the application, identify at least one differing component between the new version of the application and the prior version of the application, and deploy the at least one differing component from the new version of the application to the selected one of the virtual machines. Deployment engine 325 may further determine whether the deployment of the at least one differing component to the selected one of the virtual machines succeeded.

In response to determining that the deployment of the at least one differing component to the selected one of the plurality of virtual machines succeeded, deployment engine 325 may resume execution of the deployed instance of the application. In response to determining that the deployment of the at least one differing component to the selected one of the virtual machines did not succeed, deployment engine 325 may save a current configuration state of the selected one of the plurality of virtual machine and cause rules engine 320 to update the index of the plurality of virtual machines to indicate that the selected one of the plurality of virtual machines is in an error status.

In some implementations, deploy new version instructions 134 may deploy the new version of the application to the target virtual machine, In some implementations, the instructions to deploy the new version of the application to the target virtual machine may cause processor 110 to remove the prior version of the application from the target virtual machine and/or to replace a component of the prior version of the application with an updated component from the new version of the application.

For example, a new version (e.g., version 1.2.2) of an application may comprise a new graphics library relative to a previously deployed version (e.g., version 1.2.1) of an application. Deploy new version instructions 134 may halt execution of the previous version of the application on virtual machine 150(A). The overall application may be replaced with the new version on virtual machine 150(A) and/or only the new component, such as the new graphics library in this example, may be copied to virtual machine 150(A). The updated application may then be restarted and/or resumed on virtual machine 150(A).

In some implementations, deploy new version instructions 134 may cause processor 110 to determine whether the deployed new version of the application passes a plurality of performance tests. If an error is determined to occur during the performance tests, deploy new version instructions 134 may save a current state of the target virtual machine (e.g., configuration information, resource allocations and usage, installed applications and services, network connection information, snapshots of memory pages, etc.), and remove the target virtual machine from the pool of available virtual machines.

The disclosed examples may include systems, devices, computer-readable storage media, and methods for application deployment. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations, Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions for application deployment which, when executed by a processor, cause the processor to:
receive a new version of an application;
select, from a pool of available virtual machines, a target virtual machine comprising a prior version of the application; and
deploy the new version of the application to the target virtual machine.

2. The non-transitory machine-readable medium of claim 1, wherein the instructions to deploy the new version of the application to the target virtual machine cause the processor to remove the prior version of the application from the target virtual machine.

3. The non-transitory machine-readable medium of claim 1, wherein the instructions to deploy the new version of the application to the target virtual machine cause the processor to replace a first component of the prior version of the application with a second component of the new version of the application.

4. The non-transitory machine-readable medium of claim 1, wherein the instructions to receive the new version of the application cause the processor to:
determine whether the new version of the application passes a plurality of build tests; and
in response to determining that the new version of the application does not pass a plurality of build tests, reject the new version of the application for deployment.

5. The non-transitory machine-readable medium of claim 1, wherein the instructions to deploy the new version of the application to the target virtual machine cause the processor to:
determine whether the deployed new version of the application passes a plurality of performance tests; and
in response to determining that the deployed new version of the application passes a plurality of performance tests:
save a current state of the target virtual machine, and
remove the target virtual machine from the pool of available virtual machines.

6. The non-transitory machine-readable medium of claim 1, wherein the instructions to select the target virtual machine cause the processor to select the target virtual machine according to at least one of a plurality of deployment rules.

7. The non-transitory machine-readable medium of claim 6, wherein each of the plurality of deployment rules comprises at least one of the following: a virtual machine state condition, a virtual machine configuration condition, an application version condition, a deployment age condition, and a deployment status condition.

8. A computer-implemented method for application deployment comprising:
receiving a first version of an application for deployment;
determining whether the application is associated with a plurality of virtual machines; and
in response to determining that the application is associated with a plurality of virtual machines:
selecting, according to a deployment rule, a target virtual machine of the plurality of virtual machines, wherein the target virtual machine comprises a second version of the application,
deploying the first version of the application to the target virtual machine, and
validating the deployment of the first version of the application to the target virtual machine.

9. The computer-implemented method of claim 8, wherein the deployment rule comprises at least one of the following: a virtual machine state condition, a virtual machine configuration condition, an application version condition, a deployment age condition, and a deployment status condition

10. The computer-implemented method of claim 8, further comprising:
in response to determining that the first version of the application is not associated with the plurality of virtual machines:
creating a new virtual machine; and
deploying the first version of the application to the new virtual machine.

11. The computer-implemented method of claim 8, wherein validating the deployment of the first version of the application to the target virtual machine comprises:
determining whether a plurality of performance tests on the application on the target virtual machine succeed; and
in response to determining that the plurality of performance tests on the application on the target virtual machine did not succeed, saving a state of the target virtual machine.

12. The computer-implemented method of claim 8, wherein deploying the first version of the application to the target virtual machine comprises:
identifying at least one differing component between the first version and the second version of the application; and
replacing the at least one differing component of the second version of the application with the at least differing component of the first version of the application.

13. The computer implemented method of claim 8, wherein determining whether the first version of the application is associated with a plurality of virtual machines comprise determining whether the first version of the application comprises a major version change from the second version of the application; and
in response to determining that the first version of the application comprises a major version change from the second version of the application, deploying the first version of the application to a new virtual machine.

14. A system for application deployment, comprising:
a build engine to:
receive a new version of an application;
a rules engine to:
index a plurality of virtual machines associated with the application, wherein the index comprises a plurality of configuration information for each of the plurality of virtual machines, and
select, according to a deployment rule, one of the plurality of virtual machines for deployment of the new version of the application; and
a deployment engine to:
suspend execution of a deployed instance of the application on the selected one of the plurality of virtual machines, wherein the deployed instance of the application comprises a prior version of the application,
identify at least one differing component between the new version of the application and the prior version of the application,
deploy the at least one differing component from the new version of the application to the selected one of the virtual machines,
determine whether the deployment of the at least one differing component to the selected one of the virtual machines succeeded, and
in response to determining that the deployment of the at least one differing component to the selected one of the plurality of virtual machines succeeded, resume execution of the deployed instance of the application.

15. The system of claim 14, further comprising:
in response to determining that the deployment of the at least one differing component to the selected one of the virtual machines did not succeed:
cause the deployment engine to save a current configuration state of the selected one of the plurality of virtual machine; and
cause the rules engine to update the index of the plurality of virtual machines to indicate that the selected one of the plurality of virtual machines is in an error status.
